(19) United States
(12) Patent Application Publication
(10) Pub. No.: US 2026/0097857 A1
(43) Pub. Date: Apr. 9, 2026

(54) HYBRID-ELECTRIC PROPULSION SYSTEM FOR AN AIRCRAFT AND A CONTROL SYSTEM FOR A HYBRID ELECTRIC PROPULSION SYSTEM

(71) Applicant: Heart Aerospace Incorporated, El Segundo, CA (US)

(72) Inventors: Enis Dönmez, Göteborg (SE); Nils Carlsson, Kållered (SE)

(73) Assignee: Heart Aerospace Incorporated, El Segundo, CA (US)

(21) Appl. No.: 19/351,084

(22) Filed: Oct. 6, 2025

(30) Foreign Application Priority Data
Oct. 7, 2024 (SE) 24305120

(51) Int. Cl. B64D 31/18; B64D 27/12; B64D 27/31; B64D 27/33; B64D 31/12

(52) U.S. Cl. CPC B64D 31/18; B64D 27/12; B64D 27/31; B64D 27/33; B64D 31/12

(57) ABSTRACT

The present invention relates to a hybrid-electric propulsion comprising a first set of powerplants comprising a first electric powerplant driving a first propeller and a first gas turbine powerplant driving a second propeller, a second set of powerplants comprising a second electric powerplant driving a third propeller and a second gas turbine powerplant driving a fourth propeller; and a master control unit configured to divide power between electric power and gas turbine power. The first and the second electric powerplants are configured to provide positive engine thrust power to the aircraft during taxi-out, take-off, climb, cruise and taxi-in operations, and to provide zero or negative (e.g., non-positive) engine thrust power during descent and landing, and the first and second gas turbine powerplants are configured to provide positive engine thrust power to the aircraft during cruise, descent, and landing operations, and to provide zero engine thrust power during taxi-out and taxi-in operations.

### CROSS REFERENCE TO RELATED APPLICATIONS

This application claims the benefit of Swedish Provisional Application No., SE2430512-0 filed 7 Oct. 2024 which is incorporated herein in its entirety by this reference.

### TECHNICAL FIELD

The present disclosure relates to a hybrid electric propulsion control system and a control system for the hybrid electric propulsion system in an aircraft.

### BACKGROUND

The global goal to reduce carbon emissions will also affect the future of air travel. The aircraft industry needs to incorporate new types of propulsion systems in order to be able to reach carbon free solutions for the propulsion of aircrafts. One obvious choice is to change the propulsion systems by replacing currently used Internal Combustion Engines, ICE, (powered by carbon-based fuels) with Electric Propulsion Units, EPU, (powered by electric power from sustainable sources). However, the maturity of energy storage systems has not reached a level where the amount of energy capacity needed to conduct flights is not yet available when considering the weight of the battery systems, at least to achieve travel over reasonable distances for larger groups of passengers.

In waiting for battery systems with higher energy density/weight, alternatives to reduce carbon emissions need to be used in the transition period. One such alternative is an aircraft with an electro-hybrid propulsion system.

A challenge with having two types of propulsion units integrated in the same propulsion system is for the pilot to control the thrust of the propulsion system without having to independently instruct the different types of propulsion units (e.g., ICE and EPU propulsion units) to balance the thrust each system provides during the entire flight.

### SUMMARY

An object of the present disclosure is to provide a control system which seeks to mitigate, alleviate, or eliminate one or more of the above-identified deficiencies in the art and disadvantages singly or in any combination and to provide a method to ensure smooth operation from a pilot view.

According to an aspect of the disclosure, the inventions provide hybrid-mode systems and methods for minimizing/optimizing total fuel burn over the course of a mission. In examples scenarios, the system components, including propulsion units and control units for such propulsion units are configured such that: a) gas turbine power is used to provide thrust at an early stage of the mission (e.g., during climb), in order to stage fuel burn toward the beginning of a mission, in order to reduce aircraft mass. In further detail, the systems and methods are configured to run turbines at an efficient power point (e.g., close to the maximum continuous power, dependent upon altitude and other environmental factors). Additionally or alternatively, power distribution may be such that the portion of turbine power used during an operation mode may be below the power demand/power needed for the operation, and the systems and methods described correspondingly involve augmenting provided power using the electric propulsion units to meet demand for the operation. Additionally or alternatively, power distribution may be such that the portion of turbine power used during an operation mode is above the flight power, and the systems and methods described correspondingly involve using the turbines to charge the battery/batteries associated with the electric propulsion unit(s). Additionally or alternatively, it may be more efficient to charge/discharge the batteries rather than running the turbine at a non-optimal operating point, dependent upon the specific operation mode. In variations, the systems and methods described can provide functionality for alternating between relying upon propulsion from a single turbine vs. multiple turbines available over the course of a longer mission, in order to optimize fuel burn.

According to another aspect of the inventions described: for best fuel efficiency, the turbine propulsion unit(s) can be shut down near the start of final descent, given that associated operation modes (e.g., descent, landing, and taxi) consume less power than the efficient operating point for the turbine.

According to another aspect of the inventions described, operation modes described and proportional use of turbine power can also be adjusted based upon service life of the turbine(s). For instance, in some cases, the systems and methods can provide functionality for operating a single turbine over the entire flight rather than multiple turbines each for half the flight, in order to reduce net maintenance cost and/or maintenance scheduling aspects. The systems and methods can be structured such that the operator and/or autonomous control system components for the aircraft choose to alternate between left and right turbine usage, from one flight mission to the next (or with another suitable cadence), in order to balance wear. Additionally or alternatively, in other cases, the systems and methods can be structured to operate a turbine at a lower power setting (i.e., in a less optimal manner with respect to fuel usage), in order to strike a balance between fuel cost and turbine wear.

According to another aspect of the inventions described, the systems and methods described can provide functionality in relation to reserve and emergency situations. In a scenario, an exemplary driving case for the propulsion system relates to operations toward the end of a nominal mission (e.g., where available battery power is at the minimum nominal energy state), where, during a missed approach, one or a portion of the set of gas turbine engines fails. In this scenario, the remaining turbine(s) must supply power and energy for the full alternate mission (e.g., climb out, instrument flight rules reserves, landing, etc.). In this scenario, an exemplary solution provided the invention(s) described involve: uprating the turbine, thereby trading service life against power rating, and maintaining reserve energy such that the electric system can augment the turbine-associated deficiency for both climb and cruise operations.

Other scenarios and operation modes can, however, be provided by the invention(s) described.

According to another aspect of the present invention, this object is obtained by a hybrid-electric propulsion system for an aircraft having a first wing and a second wing mounted to a fuselage, the hybrid-electric propulsion system comprising: a first set (e.g., wing pair) of powerplants attached to the first wing, the first set (e.g., wing pair) comprising a first electric powerplant configured to drive a first propeller and a first gas turbine powerplant configured to drive a second propeller, separate from the first propeller; a second set (e.g., wing pair) of powerplants attached to the second wing, the second set (e.g., wing pair) comprising a second electric powerplant configured to drive a third propeller and a second gas turbine powerplant configured to drive a fourth propeller, separate from the third propeller; and a master control unit configured to operate each of the powerplants, wherein the master control unit is configured to divide power demand between electric power and gas turbine power. The first and the second electric powerplants are configured to provide positive engine thrust power to the aircraft during a first set of operations (e.g., taxi-out, take-off, climb, cruise and taxi-in operations); and to provide zero or negative (e.g., non-positive) engine thrust power during a second set of operations (e.g., descent and landing). The first and second gas turbine powerplants are configured to: provide positive engine thrust power to the aircraft during a third set of operations (e.g., cruise, descent, and landing); and to provide zero engine thrust power during a fourth set of operations (e.g., taxi-out and taxi-in operations).

According to another aspect of the present invention, there is a method to control a hybrid-electric propulsion system in an aircraft, wherein the method comprises the steps of: obtaining sensor data, user data and/or data retrieved from databases for the current configuration; and receiving thrust requirement from the pilot, converting thrust requirement to power demand and dividing the power demand between electric powerplants and gas turbine powerplants for each set (e.g., wing pair) of powerplants. Relatedly, a method can include controlling a hybrid-electric propulsion system of an aircraft, upon: determining a current configuration indicative of an operational state of the aircraft; determining a thrust requirement corresponding to the operational state in response to an input provided by a pilot of the aircraft; converting the thrust requirement to a power demand; dividing the power demand between a first set of electric powerplants and a second set of gas turbine powerplants of the aircraft.

The method further comprises: selecting the first and the second electric powerplants to provide positive engine thrust power to the aircraft during a first subset of conditions (e.g., taxi-out, take-off, climb, cruise and taxi-in operations); and to provide zero or negative (e.g., non-positive) engine thrust power during a second subset of conditions (e.g., descent and landing); and selecting the first and second gas turbine powerplants to provide positive engine thrust power to the aircraft a third subset of conditions (e.g., during cruise, descent, and landing); and to provide zero engine thrust power during a fourth subset of conditions (e.g., taxi-out and taxi-in operations).

An advantage with the present invention involves simplification of operations for a pilot of the aircraft, with assurance that the demanded thrust is applied in a way that improves sustainability (e.g., in relation to fuel usage), since the electric powerplants are prioritized over the gas turbine powerplants.

Further advantages and other aspects of the invention are provided in the detailed description.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1a is a perspective view of an arrangement according to one or more embodiments of the present invention.

FIGS. 1a-1c illustrate an aircraft suitable for a hybrid-electric propulsion system.

FIG. 2 is a point mass force diagram, illustrating the relationship between the forces affecting an aircraft during flight, as well as the angle of attack and flight path angle of the aircraft.

FIG. 3 is a representation of a mission profile with different phases.

FIGS. 4a-4c illustrate three different types of hybrid-electric propulsion systems.

FIG. 5 depicts a schematic of systems for dividing power demands across an electric motor control unit (EPU) and a gas turbine control unit (TCU).

FIGS. 6a-6b depict operation modes with connection diagrams depicting the electric motor control unit and gas turbine control unit (TCU), respectively.

FIG. 7 illustrates a system configuration when using the second parallel hybrid-electric configuration depicted in FIG. 4c.

FIG. 8 shows two graphs illustrating power usage during a representative flight.

FIG. 9 shows a flowchart of an embodiment of a process to control the thrust of an aircraft with a hybrid-electric propulsion system.

### DETAILED DESCRIPTION

Aspects of the present disclosure will be described more fully hereinafter with reference to the accompanying drawings. The system and/or method disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. As used herein, the singular forms “a”, “an” and “the” are intended to include the plural forms as well, unless the context clearly indicates otherwise.

Some of the example embodiments presented herein are directed towards energy management methodology. As part of the development of the example embodiments presented herein, a problem will first be identified and discussed.

A general understanding of the primary components and concepts of an aircraft is crucial for understanding the complex nature of aircraft propulsion control systems. By adding a propulsion system comprising multiple types of propulsion units, e.g. electric propulsion units (EPUs) and internal combustion engines (ICE), another level of complexity is introduced from a controlling aspect. The limited energy capacity of a battery pack providing power to the EPU requires a reserve capacity in the form of fuel, preferably sustainable aviation fuel (SAF), that drives the ICE to meet all the requirements for the aircraft from a certification point of view.

The pilot, who oversees controlling the aircraft and its propulsion system has a standard set of controls, such as a yoke for pitch and roll movement, rudder pedals for directional movement and a throttle lever angle (TLA) for thrust. When adding different types of propulsion units, there is also the possibility for the pilot to select operating mode by using any type of the propulsion units either alone or in combination. However, as will be explained in more detail below, both types of propulsion units need to be used to meet the safety requirements due to the limited energy capacity of the battery packs in the aircraft, since there might not enough energy capacity for extending the flight to another airport if required (e.g., as in a diverted flight operation), or to perform a Take-Off/Go Around (TO/GA) procedure (e.g. if an approach becomes unstable or environmental conditions do not allow a safe landing). A more advanced aircraft propulsion control system is required to handle selection/mix of the available propulsion units during a flight mission.

Below is a short description of the main components of the aircraft, the dynamics of aircraft flight, and the basic structure of a flight mission.

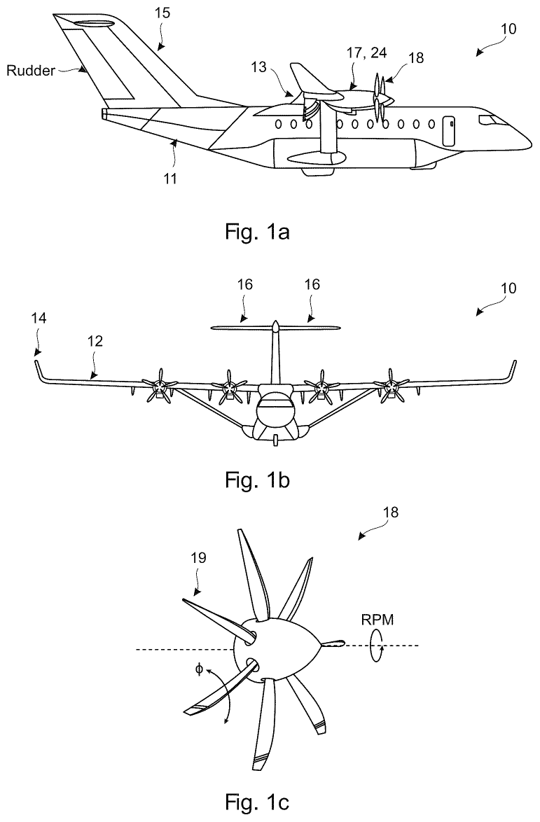

FIG. 1a and FIG. 1b illustrate views of an aircraft 10 comprising a main body, or fuselage 11, that is the central structure of the aircraft. It is usually made of lightweight materials like aluminum or composite materials and houses crew, passengers, and cargo. Attached to the fuselage are wings 12. Wings 12 have flaps 13, that adjust the aerodynamic properties of the wings, as well as ailerons 14. The ailerons, together with the vertical stabilizer 15 and horizontal stabilizers16, are crucial for stabilizing the aircraft during flight. Attached to the wings 12 are the propulsion units 17, including propellers 18.

As shown in FIG. 1a and FIG. 1b, each wing 12 of the aircraft 10 can include one or more nacelles (such as nacelle 24), which each function to at least partially house their respective propulsion units. In embodiments, a nacelle 24 can be coupled to an aircraft wing comprising a leading edge, a trailing edge, a chord from the leading edge to the trailing edge, a topside, and an underside, wherein the nacelle 24 is coupled to the wing (e.g., to the topside, the leading edge, and/or the underside of the wing 12), wherein the nacelle 24 at has a flat sidewall, a top surface, and a fillet edge between said flat sidewall and said top surface, wherein the flat sidewall is (substantially) perpendicular to the topside of the aircraft wing, wherein the fillet edge has a first local radius of curvature above the aircraft wing and a second local radius of curvature forward of the leading edge, where the first local radius of curvature and the second local radius of curvature are considered at the intersection point between the fillet edge and the flat sidewall, and wherein the second local radius of curvature is larger than the first local radius of curvature. In specific examples, a nacelle 24 coupled to the wing 12 can have an extension, from said leading edge and rearwards, in the range of 52.5-70% of the length of said chord at the transverse (or lateral) position of the nacelle attachment centerline, where the extension aspect described creates a vortex during flight operations involving high angles of attack (AOA), such that the vortex will not reattach to flow at the wing vicinity. As such, the nacelle 24 aspect described provides improved AOA characteristics in relation to stall angle of attack. Furthermore, the substantially perpendicular flat sidewall of the nacelle 24 can create and force the above-mentioned vortex (e.g., horseshoe vortex) to take place in a well-defined planar area. Furthermore, by having a larger local radius of curvature of the edge fillet forward of the leading edge, the possibilities of triggering a vortex at the (nacelle) fillet edge in front of the aircraft wing are minimized to ensure that this vortex will take place at the vicinity of the section where the first local radius of curvature is present. Overall, an improved stall angle of attack (AoA), in particular in the range of 12-14°, can be achieved using the nacelle configurations described.

The extension of the nacelle on the coupling location (e.g., topside) of the aircraft wing 12 can be expressed in relation to the length of the (local) chord of the aircraft wing 12 in clean configuration, i.e. with any flaps (and/or the like) retracted. Moreover, “said chord at the transverse position of the nacelle attachment centerline” can be virtual. Said chord may for example the average of the chord directly to the left of the nacelle and the chord directly to the right of the nacelle. Moreover, “substantially” perpendicular may be construed as 90°±5°. Moreover, “aircraft wing” may be construed as the whole wing or just a section of the wing.

The extension is preferably in the range of 59.5-66.5% of said length of the chord. This may provide high/improved maximum lift coefficient (CL) and stall AoA of the aircraft. The extension may for example be 63% of said length of the chord. Simulations made by the inventor have shown that 63% may optimize the CL max while giving the best stall AoA.

The nacelle from the leading edge of the aircraft wing may have a height in the range of 16-20% of said length of the chord, preferably 16-19%, such as 18%. Simulations made by the inventor have shown that 18% may optimize the CL max while maintaining the highest stall AoA.

In another embodiment, said extension (X-Max UP) is 45.5%, and said height (Z-Max UP) is 13%. This embodiment may be advantageous in case the wing as no flap or in case the nacelle is mounted to a wing with a flap but in a position where there is no flap behind the nacelle. The ratio between said extension (X-Max UP) and said height (Z-Max UP) is preferably 3.5, for example 63/18 or 45.5/13.

One or more propulsion units described are preferably at least partly housed in a respective nacelle 24. The propulsion unit may comprise at least one of: an electric motor, a fuel-based engine, and a propeller. The propulsion unit may for example comprise an electric motor and propeller, or a fuel-based engine and a propeller, or an electric motor and a fuel-based engine and a propeller (parallel hybrid). Accordingly, the propulsion unit may (generally) comprise a propeller. As such, a propulsion unit may for example comprise an electric motor inside the nacelle 24, which electric motor is coupled to a propeller fore of the nacelle 24. Alternatively, the propulsion unit could comprise a fuel-based engine inside the nacelle 24, which fuel-based engine is coupled to a propeller fore of the nacelle 24 (turboprop). In yet another alternative, the propulsion unit 25 comprises an electric motor and a fuel-based engine inside the nacelle 24 and a propeller outside the nacelle 24 (parallel hybrid). The nacelle 24 may comprises a front opening for a propeller shaft coupled to any one of the above-mentioned propellers.

With respect to the aircraft 10 and wing 12 configurations described, various configurations are possible, for example each wing 12 having only one nacelle 24 each housing an electric motor coupled to a propeller, each wing having two nacelles 24 each housing an electric motor coupled to a propeller, etc.

Aspects of the nacelles can include embodiments, variations, and examples of nacelle and wing components described in U.S. application Ser. No. 19/316,964, filed on 2 Sep. 2024, which is incorporated in its entirety herein by this reference.

The propellers 18 are designed with a specific number of blades 19 and diameter to match the power and performance requirements of the aircraft. While the propeller can rotate around its longitudinal axis at a selected RPM, Revolutions Per Minute, each blade 19 can also vary its relative blade pitch angle. This is illustrated in FIG. 1c.

In some embodiments, there is a close relationship between rotational speed, blade pitch angle and torque in a propeller. Each combination of blade pitch angle together with either torque or rotational speed, RPM, has a specific efficiency, and those parameters can therefore be tuned for maximal performance.

While propellors are described, the features of the aircraft components described can additionally or alternatively involve other propulsion-providing elements (e.g., impellers, etc.).

In relation to the powerplant configurations described, a first set of electric powerplants can include a first electric powerplant at the first wing and a second electric powerplant at the second wing, and a second set of gas turbine powerplants can include a first gas turbine powerplant at the first wing and a second gas turbine powerplant at the second wing. The first set of electric powerplants can include electric powerplants positioned closer to the fuselage than gas turbine powerplants of the second set of gas turbine powerplants.

The dynamics of an aircraft are based on four main forces, where the sum of the forces determines the overall acceleration of the aircraft. The four forces are thrust T, drag D, lift L, and gravitational force W.

Through the propulsion system, the aircraft produces thrust, a force along the body axis of the aircraft. The thrust is opposed by a drag force due to air resistance. By producing enough thrust, the aircraft will accelerate forward, until it reaches its take-off speed, where the shape of the wings will create enough lift to overcome the force from gravity. At that point, the sum of the forces will have a vertical component and as a result, the aircraft will take off.

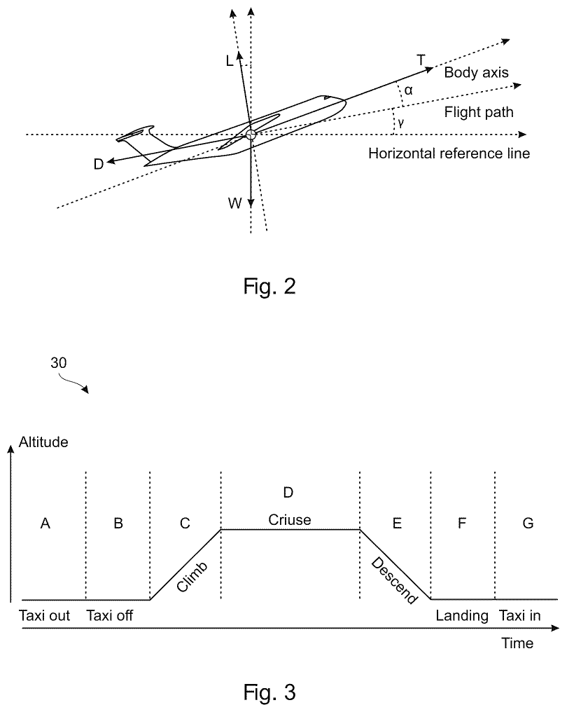

FIG. 2 describes the relationship between the four forces as a point mass force diagram, as well as the angle of attack a and flight path angle γ. The flight path angle denotes the angle at which the aircraft is moving relative to the ground. The angle of attack is the angle between the body axis of the aircraft and the flight path.

The propulsion system, having several propulsion units 17, is responsible for generating the thrust force of an aircraft. On a more detailed level, it is the propeller and propulsion system characteristics, together with the environmental conditions, that determine the specific outputs generated.

FIG. 3 illustrates an aircraft mission profile 30, which is a detailed plan for a flight journey, often described as a function of altitude, speed, and time. It typically includes the following phases:
Taxi-out: The initial phase of the flight, where the aircraft moves from its parking spot to the runway for take-off. The taxi out ends when the aircraft lines up on the runway, ready for take-off.
Take-off: The aircraft accelerates along the runway until it reaches its take-off speed and lifts off the ground, transitioning from ground to air operations.
Climb: The aircraft ascends to its cruising altitude. The pilot navigates the aircraft at a climb rate that is safe and efficient, often following a predefined path to minimize conflicts with other air traffic.
Cruise: The aircraft maintains a steady altitude, typically at high levels. During this phase, the aircraft travels the majority of the distance, with the pilot adjusting the flight path as necessary.
Descent: The aircraft leaves its cruising altitude to approach the destination airport. The pilot gradually decreases altitude, preparing for landing.
Landing: The aircraft touches down on the runway at the destination airport.
Taxi-in: The final phase of the flight, where the aircraft moves from the runway to its parking spot at the airport terminal.

In certain cases, an additional phase, go-around, may be executed if the approach to landing is deemed unsafe or if the runway is not clear. During a go-around, the aircraft aborts the landing, increases altitude, and circles back to attempt another approach. This may not be included in the mission profile, but can be taken into account in relation to determination of reserve fuel onboard the aircraft.

As described above operations for minimizing/optimizing total fuel burn over the course of a mission can be provided. In examples scenarios, the system components, including propulsion units and control units for such propulsion units are configured such that: a) gas turbine power is used to provide thrust at an early stage of the mission (e.g., during climb), in order to stage fuel burn toward the beginning of a mission, in order to reduce aircraft mass. In further detail, the systems and methods are configured to run turbines at an efficient power point (e.g., close to the maximum continuous power, dependent upon altitude and other environmental factors). Additionally or alternatively, power distribution may be such that the portion of turbine power used during an operation mode may be below the power demand/power needed for the operation, and the systems and methods described correspondingly involve augmenting provided power using the electric propulsion units to meet demand for the operation. Additionally or alternatively, power distribution may be such that the portion of turbine power used during an operation mode is above the flight power, and the systems and methods described correspondingly involve using the turbines to charge the battery/batteries associated with the electric propulsion unit(s). Additionally or alternatively, it may be more efficient to charge/discharge the batteries rather than running the turbine at a non-optimal operating point, dependent upon the specific operation mode. In variations, the systems and methods described can provide functionality for alternating between relying upon propulsion from a single turbine vs. multiple turbines available over the course of a longer mission, in order to optimize fuel burn.

According to another aspect of operation modes: for best fuel efficiency, the turbine propulsion unit(s) can be shut down near the start of final descent, given that associated operation modes (e.g., descent, landing, and taxi) consume less power than the efficient operating point for the turbine.

According to another aspect of operation modes, proportional use of turbine power can also be adjusted based upon service life of the turbine(s). For instance, in some cases, the systems and methods can provide functionality for operating a single turbine over the entire flight rather than multiple turbines each for half the flight, in order to reduce net maintenance cost and/or maintenance scheduling aspects. The systems and methods can be structured such that the operator and/or autonomous control system components for the aircraft choose to alternate between left and right turbine usage, from one flight mission to the next (or with another suitable cadence), in order to balance wear. Additionally or alternatively, in other cases, the systems and methods can be structured to operate a turbine at a lower power setting (i.e., in a less optimal manner with respect to fuel usage), in order to strike a balance between fuel cost and turbine wear.

According to another aspect operation modes, the systems and methods described can provide functionality in relation to reserve and emergency situations. In a scenario, an exemplary driving case for the propulsion system relates to operations toward the end of a nominal mission (e.g., where available battery power is at the minimum nominal energy state), where, during a missed approach, one or a portion of the set of gas turbine engines fails. In this scenario, the remaining turbine(s) must supply power and energy for the full alternate mission (e.g., climb out, instrument flight rules reserves, landing, etc.). In this scenario, an exemplary solution provided the invention(s) described involve: uprating the turbine, thereby trading service life against power rating, and maintaining reserve energy such that the electric system can augment the turbine-associated deficiency for both climb and cruise operations.

There is a wide range of propulsion systems on the market, depending on the size of the aircraft and its requirements. Broadly, these systems can be categorized into two categories; mechanical and electrical propulsion systems. Mechanical propulsion includes traditional internal combustion engines that burn fuel to create power, whereas electric propulsion relies on electrical energy to drive motors. The propulsion system of the aircraft described in connection with FIGS. 1a-1c is a propeller-driven hybrid-electric propulsion system, comprising two propeller-driven electric propulsion units and two propeller-driven gas turbines (a.k.a. turboprop engines).

Each propulsion unit comprises an electric motor, such as a Permanent Magnet Synchronous Motor (PMSM), being powered by an onboard electric energy storage system (e.g. a battery pack) via inverters that convert direct current, DC, output from the battery pack to an alternating current, AC, which is needed for energizing the electric motor.

While the battery pack supplies DC electricity, the electric motors responsible for propulsion operate on AC power. Consequently, the primary function of the inverter is to manage this conversion process, ensuring compatibility between the power source and the motor. Beyond their role in conversion, inverters play a critical role in controlling the speed and torque output of the electric motor. By receiving input signals from the aircraft's control system, which monitors various parameters such as throttle position and aircraft speed, inverters adeptly adjust their output to optimize performance in alignment with operational needs.

Furthermore, inverters commonly integrate regenerative braking functionality within electric vehicle systems. This feature empowers the electric motor to function as a generator during braking maneuvers, converting kinetic energy into electrical energy. Subsequently, the inverter facilitates the reconversion of this harvested energy into DC, thus enabling its storage in the battery for subsequent utilization. This cyclic process not only enhances energy efficiency but may also extend the operational range of the aircraft on a single charge.

Turboprop engines are a type of gas turbine engine that powers propellers to generate thrust. They are commonly used in smaller aircraft and regional airliners where efficiency at lower speeds is crucial. As a subtype of gas turbine engines, turboprops are distinguished by their ability to drive propellers directly, making them particularly well-suited for applications requiring efficient operation at lower speeds and altitudes.

The fundamental principle behind turboprop engines is the conversion of the thermal energy generated by burning fuel into mechanical energy, which is then used to drive a propeller. This process begins with the intake of air, which is compressed by the engine's compressor section. The compressed air is then mixed with fuel and ignited in the combustion chamber, where it undergoes rapid expansion, generating high-temperature, high-pressure exhaust gases. These hot gases are directed towards the turbine section of the engine, where they drive a series of turbine blades mounted on a shaft. As the gases expand and pass through the turbine blades, they transfer their energy to the turbine, causing it to rotate at high speed. This rotation is transferred to the output shaft of the engine through a reduction gearbox, which reduces the high-speed rotation of the turbine to a lower speed suitable for driving the propeller.

In embodiments, the output shaft of the turboprop engine is connected to the propeller hub, which is equipped with a set of blades or blades. As the shaft rotates, it drives the propeller blades through a series of gears, causing them to rotate and generate thrust by accelerating a large mass of air rearward. The pitch of the propeller blades can be adjusted to optimize performance for various flight conditions, allowing for efficient operation across a wide range of speeds and altitudes.

Propeller-driven hybrid-electric propulsion systems can be categorized into three exemplary types:

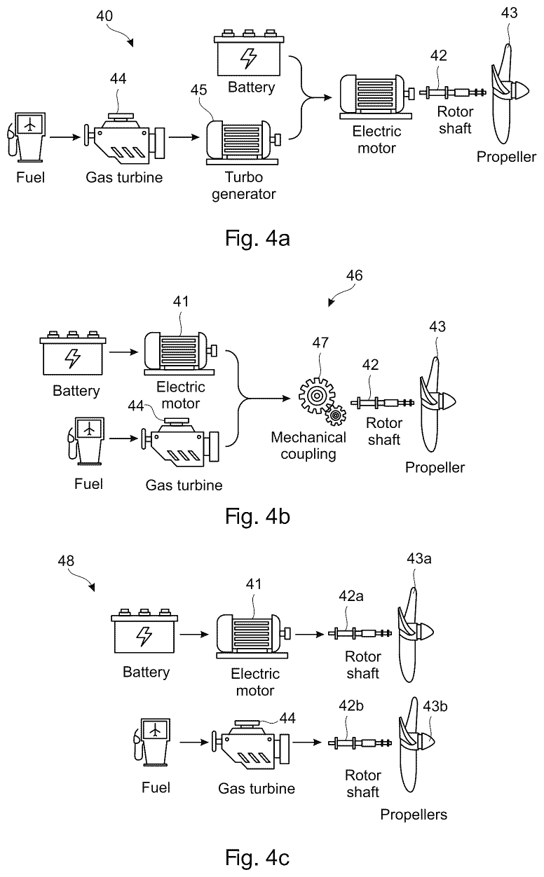

FIG. 4a shows a series hybrid configuration 40, in which only the electric motor 41 is directly connected to a shaft 42 that drives the propeller 43. The gas turbine 44 is connected to a turbo generator 45, generating electricity that is in turn used to run the electric motor 41.

FIG. 4b shows a first parallel hybrid-electric configuration 46 with mechanical coupling, in which both an electric motor 41 and a gas turbine 44 are driving the propeller 43, connected with a mechanical coupling 47, and a common shaft 42.

FIG. 4c shows a second parallel hybrid-electric configuration 48 without mechanical coupling, in which an electric motor 41 and a turboprop 44 are driving their own shaft, 42a-b and propeller 43a-b, without any mechanical coupling there between.

The aircraft control system described below is configured to control any of the hybrid-electric propulsion systems described in connection with FIGS. 4a-4c.

In embodiments, the aircraft control system is the brain of the propulsion system, responsible for translating the inputs from the pilot into readable signals to the propulsion system. The input and output signals can vary depending on the specific propulsion system and aircraft setup, this section will go over the core principles in control processes, as well as describe a hybrid control systems used for a hybrid-electric propulsion system with electric motors and gas turbines.

The general concept of any type of control mechanism is to regulate an output signal based on a sensed feedback signal. There are various controller mechanisms available for different purposes, that are suitable for different circumstances and processes, such as:
Proportional-Integral (PI) controllers that are extensively used in aircraft control systems to manage variables like speed or altitude without oscillations that a purely proportional control might induce,
Proportional-Integral-Derivative (PID) controller extends the PI controller by adding a derivative component. This third component enhances the controller's ability to predict future errors based on the rate of change of the error,
Lead-Lag filter, which is a signal processing tool used in control systems to modify the frequency response of a system. Lead-Lag filters are employed to improve the phase margin and enhance the stability of a control system. In aircraft control systems,
Lead-Lag filters are used to refine the performance of controllers, particularly in systems with complex dynamics, ensuring smooth operation and robust control under a range of operating conditions.

The control unit for the electric motor is, as the name suggests, responsible for regulating the electric motor. This can be done by either controlling the torque or the rotational speed of the motor, depending on the flight phase and specific operational requirements. This section will describe how an electric motor control system can be implemented, focusing on both torque and speed control strategies.

Torque controlled control systems involve regulating the motor's output torque to meet the required propulsion demands. Torque demand may vary depending on the flight phase, such as takeoff, climb, cruise, or descent. The control unit can either have a fixed torque setting for each flight phase or adjusts the motor's torque output based on inputs from the flight management system, pilot commands, and environmental conditions.

One approach to torque control is Direct Torque Control (DTC), which directly controls the motor's torque and flux without requiring complex coordinate transformations. Another torque control technique is Field-Oriented Control (FOC), which is a sophisticated technique used to regulate torque and flux in Permanent Magnet Synchronous Motors (PMSMs). FOC involves coordinate transformations, such as Clarke and Park transformations, converting three-phase stator currents from the stationary reference frame to a rotating reference frame. This simplifies control tasks by enabling independent control of torque-producing and magnetizing currents.

Additionally, FOC utilizes Pulse-Width Modulation (PWM) to generate voltage signals for the motor's stator windings. PWM rapidly switches inverter semiconductor devices on and off, allowing precise adjustment of voltage magnitude and frequency, thereby controlling motor speed and torque. Furthermore, FOC incorporates current control loops to regulate currents in the rotating reference frame. PI controllers adjust voltage commands based on the error between reference and measured currents, ensuring precise and responsive control over motor performance.

Speed controlled control systems regulate the motor's rotational speed to achieve desired aircraft speeds and performance characteristics during different flight phases. The control unit adjusts the motor's speed based on inputs from a flight management system, pilot commands, and operational constraints. PID control is a commonly used technique for speed control, where the control unit adjusts the motor's voltage or current to maintain the desired speed set point. PID control offers stability, accuracy, and ease of tuning, making it suitable for various speed control applications in hybrid-electric aircraft.

Model Predictive Control (MPC) is an advanced speed control strategy that predicts future motor behavior based on a mathematical model and optimally selects control actions to minimize a cost function. MPC considers system constraints and dynamic behavior, enabling precise speed regulation and optimal performance in complex operating conditions.

The control unit for turboprop engines is used to control the gas turbine and the turboprop propeller based on inputs from the pilot. The input from the pilot is generally a throttle lever angle (TLA), measured in degrees. The TLA can take any value in a set range but often comes with predefined settings for different mission phases, including take-off, idle, climb, and cruise.

Depending on the type of propulsion system, the control system can either use thrust control or power control. This section will describe how a gas turbine control system can be implemented, focusing on both thrust and power control strategies.

A thrust controlled control system is a straightforward way to control the fuel flow in an engine, to receive the desired thrust. For this to be possible, however, there needs to be a clear relationship between injected fuel and produced thrust. What makes such a relationship difficult to obtain for turboprops is the fact that the thrust is not produced by the turboprop itself, but by the specific shape of the propellers, and cannot be determined beforehand by the engine manufacturer. In that case, tables must be generated relating a specific thrust fuel flow to produced thrust. A table like that is called Thrust Specific Fuel Consumption (TSFC).

A power-controlled control system uses a power request instead of thrust request to adjust the fuel flow. A relationship like this is easier to determine for a turboprop engine, since the produced rotational power does not have to do with the specifics of the propeller. A power-controlled control system is therefore often more suitable for turboprop engines and the relationship between power produced and fuel flow can be determined with a Power Specific Fuel Consumption (PSFC) table.

Receiving the TLA from the pilot, the control system converts the value to a specific power demand. The power demand, together with sensory data of both the current engine performance as well as environmental parameters, determines the specific fuel consumption that would generate the requested power. Internal sensory data from the turboprop that the control system uses is for instance speed (RPM), temperature, and pressure, while external sensory data might include altitude and air density.

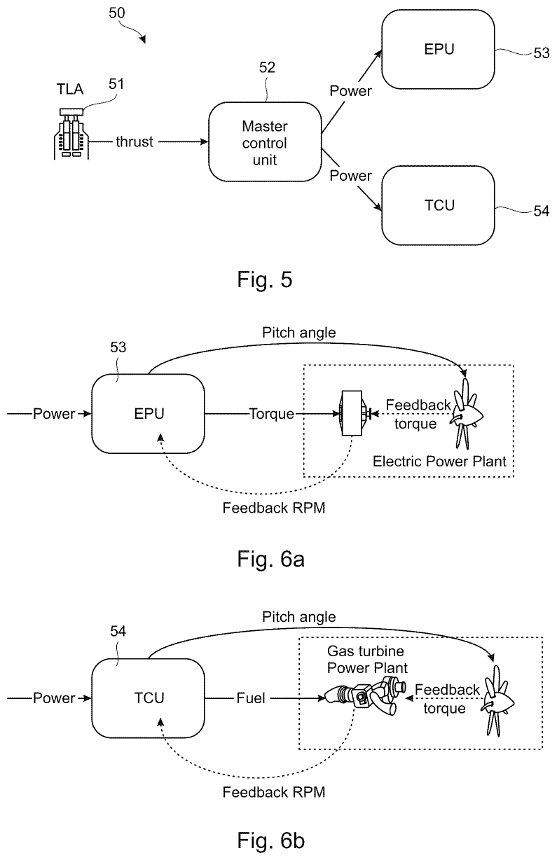

The primary function of a hybrid control system 50 for a hybrid-electric propulsion system is to receive a total thrust demand from the thrust lever angle (TLA) 51, controlled by the pilot. This thrust requirement is sent to a master control unit 52. The main task of the master unit 52 is to convert the demanded thrust to power and to divide/distribute the power demand between at least one electric motor using electric motor control unit, EPU, 53 and at least one gas turbine using a gas turbine control unit, TCU, 54 based on the power setting, as illustrated in FIG. 5. As such, the master control unit, in embodiments, is configured to divide power demand across electric power provided to a first electric powerplant and a second electric powerplant, and gas turbine power provided to a first gas turbine powerplant and a second gas turbine powerplant.

Each propulsion system's control unit, EPU and TCU, receives this power demand signal. Each electric motor control unit converts this signal into a torque demand, which is sent to the electric motor in the electric power plant, EPP. Moreover, the electric motor control unit, EPU, also sends a target blade pitch angle to the propeller, also located within the electric power plant. FIG. 6a shows the connection diagram between the electric motor control unit, EPU, and its belonging components in the electric power plant, EPP. As such, each of a first electric powerplant and a second electric powerplant can be controlled by an electric motor control unit (ECU).

Similarly, the gas turbine control unit, TCU, converts the power demand signal to fuel flow rate based on tables provided by manufacturers to the gas turbine in the gas turbine power plant, GTPP. Additionally, the TCU sends a blade pitch angle to the propellers, also located within the gas turbine power plant and being connected to the respective gas turbine. FIG. 6b shows the connection diagram between the gas turbine control unit, TCU, and its belonging components in the gas turbine power plant, GTPP. As such, each of a first gas turbine powerplant and a second gas turbine powerplant can be controlled by a gas turbine control unit (TCU).

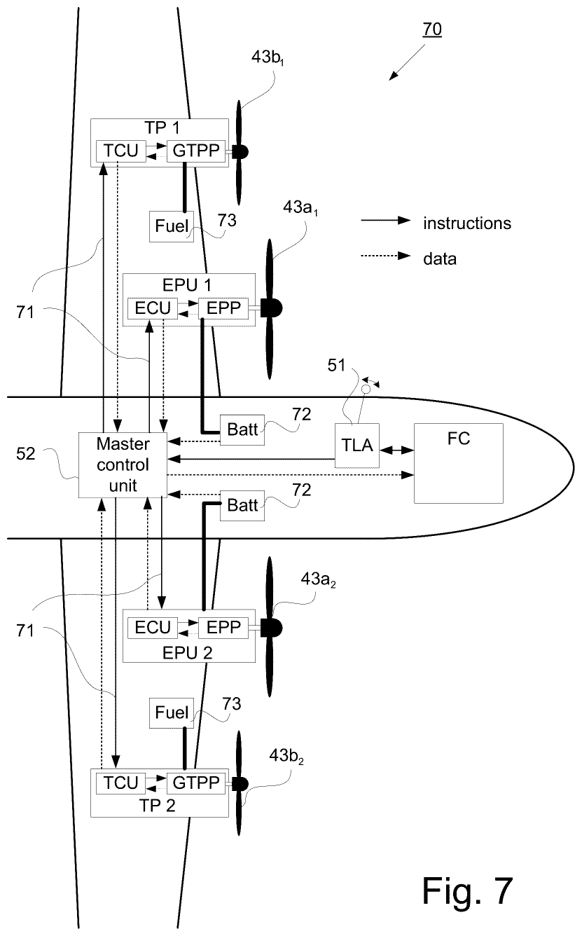

FIG. 7 illustrates a preferred system 70 configuration when using the second parallel hybrid-electric configuration, as illustrated in FIG. 4c, including in this example two electric propulsion units, EPU1 and EPU2, and two turboprop engines, TP1 and TP2, each connected to its own propeller 43a1, 43a2, 43b1, 43b2, see FIG. 7. The EPUs are powered by battery packs 72 and the turboprops receive fuel from fuel containers 73. The electric motor control units, ECUs, and gas turbine control units, TCUs, receive signals 71 sent from the master control unit 51, and the control units, ECU and TCU, controls the operation of the respective propulsion unit, EPU1-2 and TP1-2, based on the signals 71 received from the master control unit 51.

Parameters, such as efficiency for the propellers, state-of-charge voltage for batteries and power-specific fuel consumption (PSFC) for the gas turbines are measured using sensors or retrieved from tables to control the propulsion system, which in turn sends out a feedback signal of the sensed rotational speed signal to the control systems to ensure the desired torque is achieved. An output signal of the produced thrust is sent from the master control unit to the pilot instrumentation via the flight computer, FC.

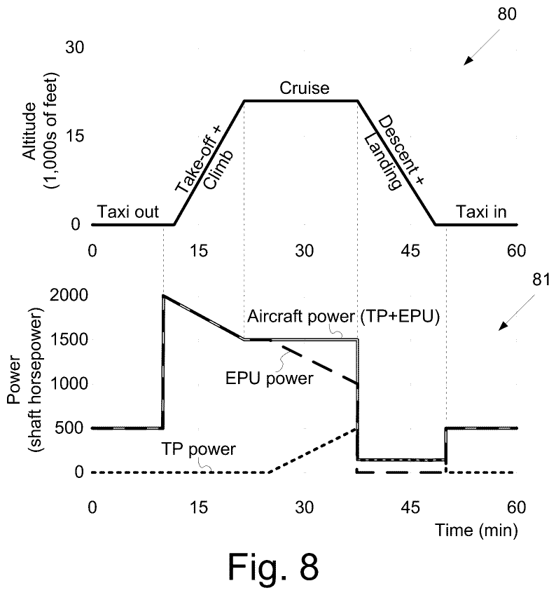

FIG. 8 shows two graphs illustrating power usage during a representative/typical flight. The upper graph 80 illustrates the altitude profile when starting from an altitude “0 feet” and landing at the same altitude after 60 minutes flight. The lower graph 81 illustrates the power usage by each type of propulsion system, TP or EPU. The pilot has in this example selected to optimize the usage of power to achieve low noise during taxi (in and out), take-off and climb, as well as reducing carbon emissions by having a high degree of electric propulsion during the entire cruise phase. The turboprops are in this example intended to be used as range extender (to ensure that the aircraft can operate at longer distances while maintaining an acceptable noise level in areas close the airports at the start and the destination of the flight route). In addition, the turboprops are maintained in idle mode during descent to ensure availability of power in case the aircraft is needed to perform a take-off/go around, TO/GA, maneuver. The turboprops may also provide power if the aircraft is redirected to another airport. In some embodiments, the first gas turbine powerplant and the second gas turbine powerplant are configured to provide positive engine thrust power to the aircraft during take-off, go-around, and maneuvering operations

### The Control System May be Controlled by the Pilot to Optimize Certain Aspects:

Carbon emissions: only use power from the battery pack to create thrust using EPU during the complete flight mission.
Noise reduction: only use power from the battery pack to create thrust using EPU at phases when the aircraft is close to populated areas. This can for instance be achieved by maintaining electric propulsion when the aircraft is below a certain altitude threshold (e.g. below 2000 feet).

The turboprops are mainly used to ensure that the aircraft can operate over a longer distance than what the battery capacity of the battery pack will allow, since the limited battery capacity of the installed battery pack only makes it possible to fly a certain distance km all electric. However, as can be seen in the lower graph 81 in FIG. 8, the turboprops are maintained in idle mode during descent even during an all-electric flight as explained in more detail below.

Turboprops may also be used during the other phases: taxi-out, take-off, climb and taxi-in operations, but the basic functionality of the hybrid-electric system is to only use the turboprops during cruise and descent, and any use during one of the other phases of flight will require the pilot to actively override the basic functionality during normal operations. In case the system detects a failure in one of the main electric components, such as the battery packs and EPUs, the master control unit will automatically enter failure mode and alert the pilot of the changed conditions and take actions to ensure safe operating conditions using both turboprops and EPUs to maintain thrust.

The turboprops are turned on during flight (using a starter motor) if more power is needed during cruise and during descent (as illustrated in lower graph 81 in FIG. 8). The EPUs are turned off during descent (optionally, the battery packs 72 are recharged by windmilling the propellers 43a1 and 43a2 during descent), and the EPUs may also be turned off completely during cruise to conserve energy while the turboprops provide thrust to the aircraft.

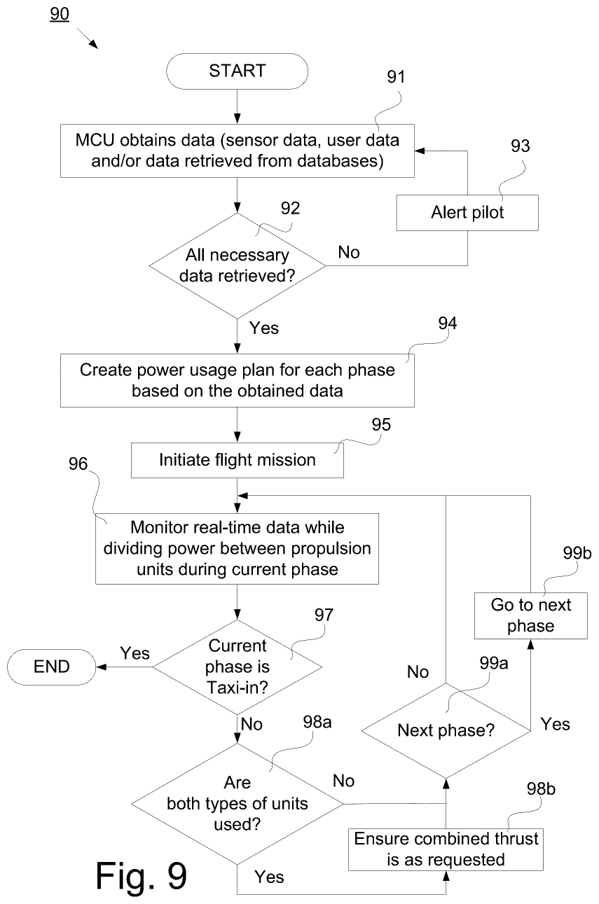

FIG. 9 shows a flowchart 90 for a process to control the thrust of an aircraft with a hybrid-electric propulsion system.

The process for controlling the hybrid-electric propulsion system comprises a first step 91, in which the master control unit, MCU, obtains data, which may be obtained as sensor data, user data and/or data retrieved from databases for a current configuration indicative of an operational state of the aircraft (variations of which are shown in FIG. 3). The sensor data includes (but are not limited to) state of charge, SOC, of each respective battery pack and total weight of aircraft. The pilot inputs user data, such as intended flight distance, intended cruise speed, intended cruise altitude, aircraft weight (if not provided by sensors), flight condition (i.e. carbon emissions and/or noise reduction), and/or other information affecting the flight performance, which are used to determine thrust requirement. If not all necessary information has been retrieved, step 92, then the pilot is alerted and prompted to provide the missing information, step 93.

When the master control unit has obtained necessary information to control of the system during the flight mission, the process continuous to step 94, in which a power usage plan corresponding to power demand is created based on the data obtained in step 91. For each phase during the flight mission, the master control unit calculates the expected thrust to arrive at the destination based on the obtained data and external parameters (e.g. weather data) that will influence the performance of the propulsion system, e.g. head wind will increase the power needed to reach destination. The power usage plan will be used as a baseline for the flight mission and the current position and status of the system will be compared against the baseline during the flight.

In step 95, the flight mission is initiated and in step 96, the master control unit, MCU, monitors real time data from sensors onboard the aircraft, while dividing the power demand between the available propulsion units on the aircraft during the current phase to meet the requested thrust by the pilot. The default setting of the MCU is shown in Table 1 and will guide the MCU when dividing power to reach the requested thrust in the different phases (unless the pilot instructs otherwise).

As an example, turboprops may be activated during take-off and climb if the runway is too short, or external conditions require higher speed than the electric propulsion system can generate.

TABLE 1

| | EPUs | TPs |
|---|---|---|
| Phase | (Electric propulsion units) | (Turboprops) |
| Taxi-out | X | |
| Take-off | X | |
| Climb | X | |
| Cruise* | X | X |
| Descent | | Idle |
| Landing | | Idle |
| Take-Off/Go Around** | | X |
| Taxi-in | X | |

*split between different types of propulsion units is based on the data provided in step 91. Short flights will have a higher percentage of thrust generated by EPUs compared to longer flights when TPs will generate a higher percentage of thrust during cruise.
**TO/GA will require substantial amounts of energy at the end of the flight when the energy capacity of the battery pack is low, and TPs is maintained in idle mode during descent to provide this functionality in case it is needed.

The MCU continuously monitor the current phase to determine if the flight mission is over or not. If the current step is “taxi-in”, step 97, it means that the flight mission is over as soon as the aircrafts comes to a stop at the arrival gate. If the current phase in not “Taxi in”, then the process continuous to step 98a.

If both types of propulsion units, EPUs and TPs, are used, as determined in step 98a, the process continuous to step 98b where the MCU ensures that the requested thrust by the pilot is delivered as a combined thrust from the propulsion units. This is especially important if the division of power changes during the current phase. In one example embodiment, the ECU and the TCU on each wing are configured to exchange information regarding thrust generated, and this information is provided to the MCU to ensure that the thrust on each wing is as expected. For instance it is desired to generate the same amount of thrust on each wing under normal conditions.

The MCU receives information in step 99a to move to the next phase step 99b of the flight mission from the pilot, or the MCU continuous to monitor real-time data while dividing power between the EPUs and TPs for the current phase until a decision is made to proceed to the next phase.

It should be appreciated that a flowchart comprises some operations which are illustrated with a solid border and some operations which are illustrated with a dashed border. The operations which are comprised in a solid border are operations which are comprised in the broadest example embodiment. The operations which are comprised in a dashed border are example embodiments which may be comprised in, or a part of, or are further operations which may be taken in addition to the operations of the broadest example embodiments. It should be appreciated that these operations need not be performed in order. Furthermore, it should be appreciated that not all of the operations need to be performed. The example operations may be performed in any order and in any combination.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A system for an aircraft having a first wing and a second wing mounted to a fuselage, the system comprising:
a first set of powerplants attached to the first wing, the first set of powerplants comprising a first electric powerplant configured to drive a first propeller and a first gas turbine powerplant configured to drive a second propeller independently of the first propeller;
a second set of powerplants attached to the second wing, the second set of powerplants comprising a second electric powerplant configured to drive a third propeller and a second gas turbine powerplant configured to drive a fourth propeller independently of the third propeller; and
a master control unit configured to operate each of the powerplants,
wherein the master control unit is configured to divide power demand across electric power provided to the first electric powerplant and the second electric powerplant, and gas turbine power provided to the first gas turbine powerplant and the second gas turbine powerplant,
wherein the first electric powerplant and the second electric powerplant are configured to provide positive engine thrust power to the aircraft during a first set of operations and to provide non-positive engine thrust power to the aircraft during a second set of operations, and
wherein the first gas turbine powerplant and the second gas turbine powerplant are configured to provide positive engine thrust power to the aircraft during a third set of operations, and to provide zero engine thrust power to the aircraft during a fourth set of operations.

2. The system of claim 1, wherein the first set of operations comprises taxi-out, take-off, climb, cruise and taxi-in operations.

3. The system of claim 1, wherein the second set of operations comprises descent and landing operations.

4. The system of claim 1, wherein the third set of operations comprises cruise, descent, and landing operations.

5. The system of claim 1, wherein the fourth set of operations comprises taxi-out and taxi-in operations.

6. The system of claim 1, wherein the first gas turbine powerplant and the second gas turbine powerplant are further configured to provide positive engine thrust power to the aircraft during take-off and climb operations.

7. The system of claim 2, wherein the first gas turbine powerplant and the second gas turbine powerplant are further configured to provide positive engine thrust power to the aircraft during take-off, go-around, and maneuvering operations.

8. The system of claim 2,
wherein each of the first electric powerplant and the second electric powerplant is controlled by an electric motor control unit (ECU) and each of the first gas turbine powerplant and the second gas turbine powerplant is controlled by a gas turbine control unit (TCU), and
wherein and the master control unit is configured to control the first electric powerplant and the second electric powerplant via the ECU, and control the first gas turbine powerplant and the second gas turbine powerplant via the TCU.

9. A system comprising:
a first set electric powerplants;
a second set of gas turbine powerplants; and
a master control unit configured to operate each of the first set of electric powerplants and the second set of gas turbine power plants independently,
wherein the master control unit is configured to divide power demand across electric power provided to the first set of electric powerplants and gas turbine power provided to the second set of gas turbine powerplants according to a first constraint wherein the first set of electric powerplants provides positive engine thrust power during a first set of operations and provides non-positive engine thrust power during a second set of operations, and according to a second constraint wherein the second set of gas turbine powerplants and the second gas turbine powerplant are configured to provide positive engine thrust power during a third set of operations, and to provide zero engine thrust power during a fourth set of operations.

10. The system of claim 9, wherein the first set of operations comprises taxi-out, take-off, climb, cruise and taxi-in operations.

11. The system of claim 9, wherein the second set of operations comprises descent and landing operations.

12. The system of claim 9, wherein the third set of operations comprises cruise, descent, and landing operations.

13. The system of claim 9, wherein the fourth set of operations comprises taxi-out and taxi-in operations.

14. The system of claim 9, further comprising an aircraft comprising a first wing and a second wing coupled to a fuselage, wherein the first set of electric powerplants comprises a first electric powerplant at the first wing and a second electric powerplant at the second wing.

15. The system of claim 14, wherein the second set of gas turbine powerplants comprises a first gas turbine powerplant at the first wing and a second gas turbine powerplant at the second wing.

16. The system of claim 15, wherein the first set of electric powerplants comprises electric powerplants closer to the fuselage than gas turbine powerplants of the second set of gas turbine powerplants.

17. A method comprising:
controlling a hybrid-electric propulsion system of an aircraft, upon:
determining a current configuration indicative of an operational state of the aircraft;
determining a thrust requirement corresponding to the operational state in response to an input provided by a pilot of the aircraft;
converting the thrust requirement to a power demand;
dividing the power demand between a first set of electric powerplants and a second set of gas turbine powerplants of the aircraft, according to a set of conditions comprising:
a first subset of conditions wherein the first set of electric powerplants provides positive engine thrust power to the aircraft during taxi out, take-off, climb, cruise and taxi in operations,
a second set of conditions wherein the first set of electric powerplants provides non-positive engine thrust power during descent and landing operations,
a third set of conditions wherein the second set of gas turbine powerplants provides positive engine thrust power to the aircraft during cruise, descent, and landing operations, and
a fourth set of conditions wherein the second set of gas turbine powerplants provides zero engine thrust power during taxi-out and taxi-in operations.

18. The method of claim 17, wherein the third set of conditions further comprises provision of positive engine thrust power to the aircraft during take-off and climb operations.

19. The method of claim 17, wherein determining the current configuration of the aircraft comprises interrogating a sensor system comprising sensors in communication with a set of control surfaces of the aircraft.

20. The method of claim 17, wherein the first set of electric powerplants is controlled by an electric motor control unit (ECU) and the second set of gas turbine powerplants is controlled by a turbine control unit (TCU) with a data link between the ECU and the TCU, the method further comprising:
determining a combined thrust value upon processing thrust parameters associated with the first set of electric powerplants and the second set of gas turbine powerplants, upon accessing the ECU and the TCU by way of the data link,
transmitting the combined thrust value to a master control unit of the aircraft, and
at the master control unit, determining, from the combined thrust value, a first thrust provided by a first subset of powerplants positioned at a first wing of the aircraft, and a second thrust provided by a second subset of powerplants positioned at a second wing of the aircraft.
